(19) United States
(12) Patent Application Publication
(10) Pub. No.: US 2012/0143733 A1
(43) Pub. Date: Jun. 7, 2012

(54) INVOICING FOR ITEM HANDLING EVENTS

(75) Inventor: Jens Kappauf, Schriesheim (DE)

(73) Assignee: SAP AG, Walldorf (DE)

(21) Appl. No.: 12/957,982

(22) Filed: Dec. 1, 2010

(51) Int. Cl. G06Q 30/00; G06Q 10/00

(52) U.S. Cl. 705/32; 705/34

(57) ABSTRACT

According to an example embodiment, a non-transitory computer-readable storage medium may include instructions stored thereon that, when executed by a processor, result in a computing system receiving an event stream. The event stream may include event messages that document events occurring in relation to items being handled by an item handling service provider, and each of the event messages may be associated with instructions from a customer of the item handling service provider. The execution of the instructions may also result in the computing system classifying the event messages as events based on classification rules associated with the respective customers of the service provider. The execution of the instructions may also result in the computing system determining an aggregated fee associated with a subset of the events based on pricing rules associated with the respective customers of the service provider. The execution of the instructions may also result in the computing system generating an invoice for the customers of the service provider based on the aggregated fees determined for the subset of events.

### TECHNICAL FIELD

This description relates to billing in general, and more specifically to billing for item handling or warehousing services.

### BACKGROUND

Warehouse or item handling service providers may provide item handling services to customers, such as storing, putting away, internally routing, rearranging, maintaining, counting, inspecting, deconsolidating, validation, correcting, slotting, claims receipt, labeling, wrapping, packaging, palletizing, kitting, returns, use or application of facilities or equipment, scrapping, recycling, staging and loading or unloading the items, placement into bins, and transporting of items, such as goods, freight, or cargo. Some of the services may be performed directly by the warehouse or item handling service provider, whereas others may be provided by third parties who contract with the service provider. The service provider and the third parties may provide electronic updates, or handling event messages, with respect to the services performed on, or the status of, the items, which may be routed to a central computing device or system. The service provider may find it difficult to quickly generate invoices which meet its customers' needs.

### SUMMARY

According to one general aspect, a non-transitory computer-readable storage medium may include computer-readable instructions stored thereon that, when executed by a processor, result in a computing system receiving an event stream. The event stream may include event messages that document events occurring in relation to items being handled by an item handling service provider, and the event messages may be associated with instructions from a customer of the item handling service provider. The execution of the instructions may also result in the computing system classifying the event messages as events based on classification rules associated with the respective customers of the service provider. The execution of the instructions may also result in the computing system determining an aggregated fee associated with a subset of the events based on pricing rules associated with the respective customers of the service provider. The execution of the instructions may also result in the computing system generating an invoice for the customers of the service provider based on the aggregated fees determined for the subset of events.

According to another general aspect, a method may include receiving, by a computing system, an event stream. The event stream may include event messages that document events occurring in relation to items being handled by an item handling service provider, and the event messages may be associated with instructions from a customer of the service provider. The method may also include classifying the event messages as events based on classification rules associated with the respective customers of the service provider. The method may also include determining an aggregated fee associated with a subset of the events based on pricing rules associated with the respective customers of the service provider. The method may also include generating an invoice for the customers of the service provider based on the aggregated fees determined for the subset of events.

According to another general aspect, an apparatus may include at least one processor and at least one memory. The at least one memory may include instructions stored thereon that, when executed by the at least one processor, result in the apparatus receiving an event stream. The event stream may include event messages that document events occurring in relation to items being handled by an item handling service provider, and the event messages may be associated with instructions from a customer of the item handling service provider. The execution of the instructions may also result in the apparatus classifying the event messages as events based on classification rules associated with the respective customers of the service provider. The execution of the instructions may also result in the apparatus determining an aggregated fee associated with a subset of the events based on pricing rules associated with the respective customers of the service provider. The execution of the instructions may also result in the apparatus generating an invoice for the customers of the service provider based on the aggregated fees determined for the subset of events.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of a computing system and data sources according to an example embodiment.

FIG. 2 is a block diagram showing modules of a processor of the computing system, and messages forwarded by the modules, according to an example embodiment.

FIG. 3 is a block diagram of a memory of the computing system according to an example embodiment.

FIG. 4 is a flowchart of a method according to an example embodiment.

FIG. 5 is a block diagram of an architecture for processing handling event messages and generating invoices according to an example embodiment.

FIG. 6 is a block diagram showing modules of the processor of the computing system of FIG. 1, and data forwarded by the modules, according to another example embodiment.

### DETAILED DESCRIPTION

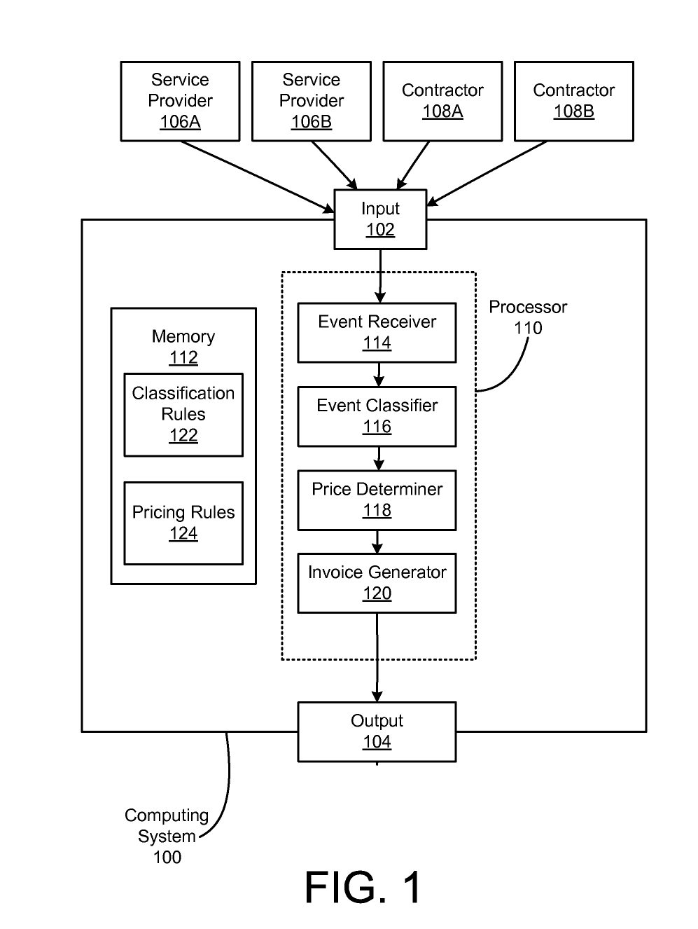

FIG. 1 is a block diagram of a computing system 100 and data sources according to an example embodiment. The computing system 100 may include, for example, a server, a personal computer, a laptop or notebook computer, a tablet computer, a Smartphone, or any other computing system capable of receiving data, executing instructions or performing operations on the data, and/or providing an output based on the data and the executed instructions or performed operations, and combinations thereof. The functions of the computing system 100 may also be distributed to two or more computing devices or systems; for example, the computing system 100 may include multiple computing devices, which may each be capable of receiving data, executing instructions or performing operations on the data, providing an output based on the data and the executed instructions or performed operations, and sharing the data with the other computing devices within the computing system 100 to perform the tasks and functions described herein. The computing system 100 may receive item handling event messages, which may correspond to item handling events or warehouse activities and may document handling events occurring in relation to items handled by an item handling service provider, which may be part of an order of items or order for transportation of items, or be associated with or in accordance with instructions by a customer of the item handling service provider, and generate invoices based on the messages.

The invoice may include the specific tasks indicated by the messages, and/or may aggregate or classify the tasks and provide pricing for each classification or group of tasks performed. The pricing per task may be customizable based upon the provider of the warehouse or item handling service provider, and/or based on the customers or recipients of the item handling services. For example, an item handling service provider may have contracts with different item handling service recipients or customers, and may have different pricing agreements with each of the recipients or customers.

The computing system 100 may receive input in the form of item handling event messages reporting tasks or handling events performed by the item handling service provider, and/or item handling event messages reporting tasks performed by outside contractors hired by the item handling service provider, and may provide billing statements or invoices based on the received input. The item handling service provider may, for example, charge storage fees for storing items or cargo at a warehouse, equipment costs for using facilities at the warehouse, transportation fees for transporting the items, handling fees for inbound and outbound processing, such as loading and unloading the items onto and off of freight carriers such as trucks from and into a storage facility or warehouse, and over-capacity charges in cases in which the customer of the item handling services exceeds storage space available, as non-limiting examples.

The handling events may be associated with and/or performed in accordance with instructions by a customer of the item handling service provider. The customer may provide instructions based upon which the handling events are performed, but may not necessarily provide instructions at the level of detail of the handling events. For example, the customer may have provided instructions to the item handling service provider to pick a shipment of items up from a first location, store the items in a warehouse, and deliver the items to a second location. The item handling service provider may, based on these instructions, inspect the items at the first location, load the items onto the truck at the first location, transport the items from the first location to the warehouse, unload the items at the warehouse, label and package the items at the warehouse, count, route, and store the items at the warehouse, select and load the items from the warehouse onto a truck, transport the items from the warehouse to the second location, unload the items from the truck at the second location, count and inspect the items at the second location, and deliver the items at the second location, using any combination of actions and services performed by the item handling service provider and third party contractors.

The item handling service provider may also perform these tasks described in paragraph [0016] based on instructions to transport the items from the first location to the second location and based on a determination by the item handling service provider that the items cannot be transported directly from the first location to the second location but must be stored temporarily before delivery to the second location. The item handling service provider may also perform predetermined actions or tasks for a given instruction, such as inspecting, loading, transporting, unloading, and inspecting items in response to a delivery instruction from a customer, and/or unload, count, label, package, route, and store items in response to a storage instruction from a customer.

The computing system 100 may include an input module 102. The input module 102 may include any combination of input modules which receive data from sources outside the computing system 100, and may receive data according to various communication and/or networking protocols. For example, the input module 102 may receive data from a keyboard or mouse, or from a local area network, a wide area network, or the Internet, and/or may include an Ethernet port, a USB port, or a wireless interface such as IEEE 802.11, 802.15, 802.16, or cellular communication and networking interfaces, as non-limiting examples. The input module 102 may receive data from different service providers, including the item handling service provider or third party contractors. The computing system 100 may transform these data into item handling events and generate an invoice based on the item handling events.

The computing system 100 may also include an output module 104. The output module 104 may include, for example, a display or flat-screen monitor, a printer, or a data output module such as an Ethernet port, a USB port, or a wireless interface such as IEEE 802.11, 802.15, 802.16, or cellular communication and networking interfaces, as non-limiting examples. The output module 104 may display, print, or send the generated invoice.

The computing system 100, as discussed above, may receive the data from multiple item handling service providers and/or contractors. For example, the computing system 100 may receive the data from item handling service providers 106A, 106B. The computing system 100 may receive the data on behalf of, and generate the invoices for, multiple service providers 106A, 106B. The service providers 106A, 106B may contract with an owner or operator of the computing system 100 for the purpose of tracking and generating invoices based on the item handling events, or a service provider 106A, 106B may itself own and maintain the computing system 100. The computing system 100 may generate the invoices, which may include prices and classifications of services, based on rules provided by each service provider 106A, 106B. Each service provider 106A, 106B may also customize its classification and pricing rules for its respective customers or recipients of the item handling services. The computing system 100 may also receive input from third party contractors 108A, 108B which have been hired by a service provider 106A, 106B. For example, the computing system 100 may receive data from Federal Express, United Parcel Service, or other transportation service providers, and/or may receive input from contracted trucking or transportation service providers, or from contracted storage providers.

The data received from the different service providers and contractors 106A, 106B, 108A, 108B may be in different formats. For example, the service providers 106A, 106B may provide their data to the computing system 100 via logging into a web browser, whereas the contractors 108A, 108B may provide the data via email or text message. The data included in the email or text message, for example, may be in different formats as well. For example, each of the contractors 108A, 108B may have its own coding system for services performed or items delivered, or may provide the information in different formats, such as comma separated value spreadsheets.

The computing system 100 may receive these different handling event messages via the input 102. The data received from these service providers 106A, 106B and contractors 108A, 108B may be considered handling event messages. The data received may correspond to handling events, such as storage, picking up, shipping, and delivery of items. The providers 106A, 106B and contractors 108A, 108B may provide the item handling messages corresponding to the item handling events to the computing system 100 in real time. Thus, these handling event messages may constitute an event stream which is continuously updating the computing system 100 on the status of orders and deliveries with respect to items, or groups of items within a shipment.

The computing system 100 may include a processor 110. The processor 110 may be capable of executing instructions and performing tasks such as those described in this disclosure. The computing system 100 may also include a memory 112. The memory 112 may store classification rules 122 for classifying item handling events, may store pricing rules 124 for pricing the item handling events, and may also store instructions for execution by the processor 110. The processor 110 may receive the handling event messages from the input 102 and classify the handling event messages as handling events according to the rules stored in the memory 112. The processor 110 may also determine fees or prices associated with any subset of the handling events based on the pricing rules stored in the memory 112. The classification rules 122 and pricing rules 124 may be customized and/or updated for each of the item handling service providers 106A, 106B and/or each of the customers of the item handling service provider. The processor 110 may also generate the invoice for the customers based on the determined fees or prices.

The processor 110 may include an event receiver 114. The event receiver 114 may receive the handling event messages received by the computing system 100 from the service providers 106A, 106B and contractors 108A, 108B via the input 102. The handling event messages may indicate the service performed, and may include the source (i.e., service provider 106A, 106B or contractor 108A, 108B) of the handling event, an identifier of the item or group of items, a timestamp indicating a beginning or end of the event (such as when the item(s) was picked up or delivered or when the item(s) was placed into or retrieved from storage), and/or a time duration for which the item(s) was transported or stored. The source identifiers, item identifiers, timestamps, and/or time durations may be associated with each other for the purpose of indicating who performed the service, on what item, and the details of the service. For example, a handling event message may indicate the source to be Federal Express, identify the item as a particular package picked up on a particular date and time from a particular address, and identify the date, time, and address at which the item was delivered. The event receiver 114 may forward the handling event messages to the event classifier 116.

The event classifier 116 may classify the handling event messages as handling events according to classification rules 122 for the provider and/or customer of the item handling services. The event classifier 116 may classify the item handling event messages as item handling events according to a hierarchical classification in which events are classified and further subclassified, or according to a flat classification that simply has handling events associated with handling event messages, all according to the classification rules 122 stored in the memory 112.

According to a hierarchical classification example, the handling events may be classified within categories which include inbound processing, storage and operations, outbound processing, or sales and service. For example, inbound processing may include operations or actions related to items being brought into a warehouse, such as inbound delivery processing, transportation unit handling, put away bin determination, internal routing, quality inspection, deconsolidation or inspection of goods received, validation and correction of the items, transportation unit arrival, receipt of the goods, slotting, deconsolidation, put away returns or reverse logistics (which may include sending back items which are defective or damaged), and claims receipt optimization and returns of the items. Storage and operations may include storage and maintenance of items within the warehouse, such as rearrangement of the items, replenishment or maintenance of the items, counts of the inventory of the items, resource management or labor management with respect to the items, inventory counts and record accuracy, replenishment, kit to stock, and freight and order management. Outbound processing of the items may include operations or actions related to items being taken out of the warehouse, such as wave management and picking of the items, determining correct traffic routes to carry the items, staging and loading the goods or items to a freight carrier such as a truck, deployment or sending the items off on trucks, determining the correct bins to place items in, warehouse order creation, work assignment, picking and packing of the items, manual outbound deliveries, and production supply. Other examples of hierarchical or non-hierarchical classification may be applied by the processor 110 based on the classification rules 122.

According to another hierarchical classification, the handling events may be classified as either actions or services. In this example, actions may be executed events performed on the items by persons, such as inbound or outbound processing actions described above, warehouse activities, and movements of the items. The actions may be measured by an amount or duration of labor performed, number of items or pieces included in the items, weight of the items, or volume of items. The handling event messages, classified handling events, and determined fees associated with actions may include or be based on the amount or duration and type of labor performed, number of items or pieces included in the items, weight of the items, or volume of items.

Services may include utilization of physical resources, such as warehouse space or use of equipment. The services may be measured by time, such as days or hours of use, and in the case of warehouse space, by space occupied, which may be measured by an average or maximum amount of warehouse space occupied. The handling event messages, classified handling events, and determined fees associated with actions may include or be based on the measured and reported time and/or space occupied, in this example.

As further examples, the event classifier 116 may classify the handling events as storage for keeping cargo at the warehouse, equipment services for use of facilities, such as forklifts or other equipment, capacity charges if the goods require more storage space than contracted, lease fees which may be based on time, number, volume, and weight of the items, value added services which may include, for example, scrapping fees for damaged items, recycling fees, labeling, packaging, palletizing, kitting, wrapping, and overtime work with respect to the items, inspecting the items, and management services.

The event classifier 116 may also aggregate the handling events according to the classification rules 122 for the respective customer of the item handling services. The event classifier 116 may, for example, aggregate the handling events into classifications such as as transportation services, warehouse services, and value added services, or may, at a lower level, classify transportation services as freight services, port services, handling services, and detention services, and may classify warehousing services as warehouse handling services, resource and warehouse utilization services, and/or valued added services (such as packaging, wrapping, kitting, and/or lean-production services), according to the classification rules 122 for the respective customer of the item handling services.

Upon classifying the handling events, the event classifier 116 may provide the classified handling events to a price determiner 118 included in the processor 110. The classified handling events may include the event classification, as well as other information, such as terms or indicators to associate the events with the handling event service provider 106A, 106B and the item handling service customer. The classified handling events may also include other information such as item quantity, weight, volume, any restrictions with respect to the items, such as contracted minimums or maximums or handling restrictions which may be relevant to pricing, and the time and duration of labor, equipment, and storage facilities which may be relevant to pricing. The event classifier 116 may forward this information to the price determiner 118.

The price determiner 118 may determine prices for the classified handling events based on the pricing rules 124 stored in the memory 112 for the respective customer and provider of the item handling services. The price determiner 118 may calculate storage, handling, and other charges based on the performed item handling services or activities. The price determiner 118 may determine the prices based on agreements with the respective customers of the item handling service provider, and may be based on individual charges with respect to different types of items. The price determiner 118 may determine prices based on, for example, receiving items, loading the items onto trucks, transporting the items, unloading the items, and putting the items away into storage and/or picking the items up from storage. Other services which may be billed or priced according to the pricing rules 124, which may be considered value added services, may include packaging, labeling, re-palletizing, inspection, and/or exception handling. The price determiner 118 may also provide billing for rentals, such as billing for rental space, which may be based on, for example, an average amount of inventory or space utilized over a period of time, a maximum or minimum inventory level, an inventory snapshot, or initial storage charges.

The price determiner 118 may also aggregate a subset of the classified item handling events for respective customers of the item handling service providers. The price determiner 118 may, for example, aggregate fees for a subset of the handling events which may, for example, be all item handling events provided for a certain customer of an item handling service provider over a period of time, such as a month, or item handling services provided with respect to a certain shipment of items upon completion of the shipment of the items, according to the pricing rules 124. The price determiner 118 may provide the aggregated fees to an invoice generator 120.

The invoice generator 120 may generate invoices for each of the customers of the item handling service providers based on the fees or prices determined by the price determiner 118. The invoice generator 120 may, for example, generate the invoice according to a format requested by the provider of the item handling services so that the provider may provide a consistent appearance on its invoice to all of its customers. The format of the invoice may be included in the pricing rules 124, according to an example embodiment.

As discussed above, functions or processes performed by the computing system 100, such as functions performed by any combination of the event receiver 114, event classifier 116, price determiner 118, and invoice generator 120, may be performed by a single computing device, or may be distributed between multiple computing devices. In one example, a first computing device may include the events receiver 114 and event classifier 116, which receive the handling event messages and classify the handling event messages, respectively, as described above. In this example, the first computing device may send the classified handling events to a second computing device. The second computing device may receive the classified handling events from the first computing device. The second computing device may include the price determiner 118 and invoice generator 120, which determine the fees associated with the classified handling events and generate the invoice, respectively, as described above. Other combinations of computing devices may perform the functions and processes described herein.

Also as discussed above, the memory 112 may include classification rules 122 and pricing rules 124. The classification rules 122 may be accessed by the event classifier 116 for the purpose of classifying the item handling event messages as item handling events. The pricing rules 124 may be accessed by the price determiner 118 for the purpose of determining prices or fees associated with handling events for a given customer and provider of item handling services. The classification rules 122 and/or pricing rules 124 may be customized and updated by the respective service provider 106A, 106B, or by an operator of the computing system 100, as the service providers 106A, 106B acquire new customers or recipients of the item handling services, or as service agreements are renegotiated.

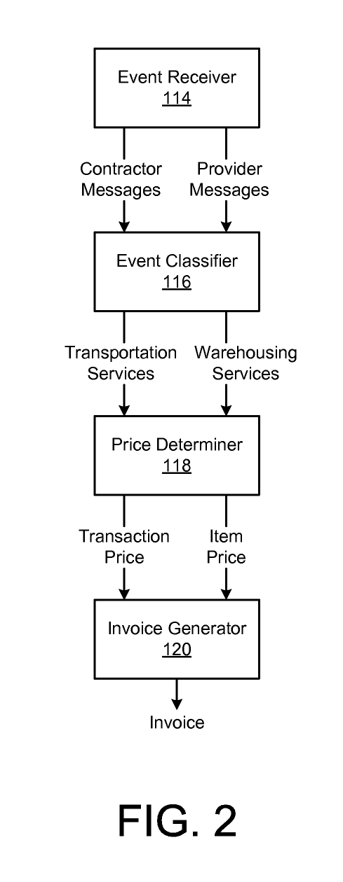

FIG. 2 is a block diagram showing messages provided by the modules of the computing system 100, and messages forwarded by the modules within the processor 110, according to an example embodiment. In this example the event receiver 114 may provide contractor messages and provider messages to the event classifier 116. The event receiver 114 may, for example, receive and forward the contractor messages to the event classifier 116. The contractor messages may include item handling event messages received and forwarded from third party contractors, such as shipping service providers, equipment operators, or moving service providers. The contractors may send contractor messages to the computing system 100 by various means, such as email, text messages, or a web-based login interface, as non-limiting examples. The provider messages may be the data input directly into the computing system 100 by the provider of the item handling services, which may be a customer of the owner of the computing system 100.

The event classifier 116 may classify the item handling messages, which may include the contractor messages and provider messages, as item handling events and send the classified events to the price determiner 118. In a broad classification, the event classifier 116 may classify the item handling event messages as transportation services and warehousing services. The transportation services may, for example, include the item handling events of loading a freight vehicle, such as loading a truck with the items, transporting the items to their destination, and unloading the freight carrier or truck at the destination. The warehousing services may include receipt and intake of the items, wrapping or labeling the items, inspecting the items, storing the items, indexing the items, finding the items, and providing the items to a transportation service provider.

The price determiner 118 may receive the classified handling events and generate prices for each of the classified events. The price determiner 118 may provide prices based on transactions, such as a transaction to receive, store, transport and deliver a group of items on behalf of a customer of item handling services, or may generate prices based on each handling event, such as a fee per handling event. The price determiner 118 may provide these prices and their associated descriptions to the invoice generator 120. The invoice generator 120 may generate and output the invoice including these determined prices or fees. The invoice generator 120 may detail each of the fees, or may aggregate subsets of the fees, according to the pricing rules 124 for the respective customer and provider of the item handling services.

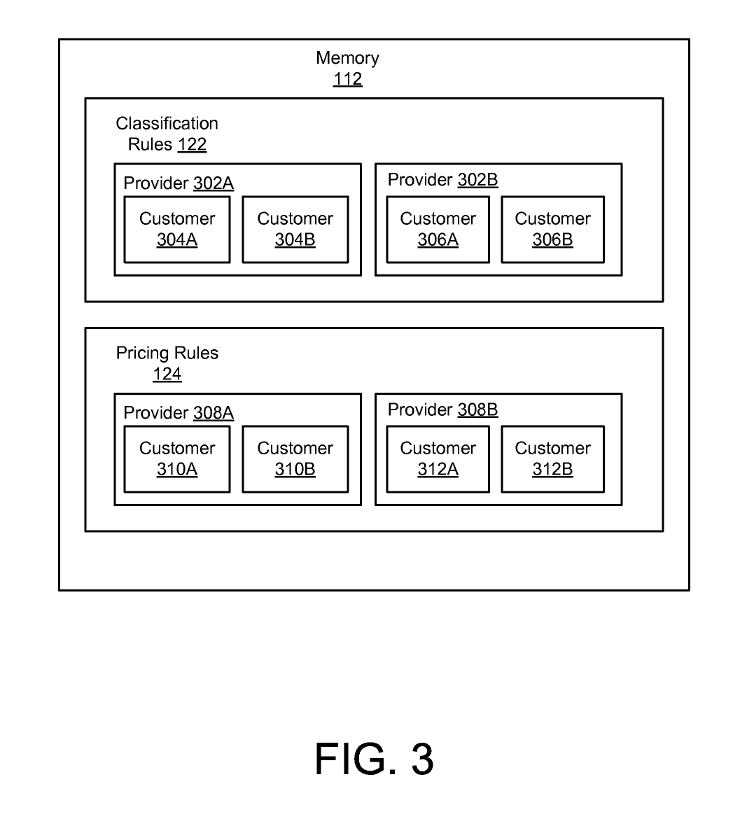

FIG. 3 is a block diagram of the memory 112 shown in FIG. 1 according to an example embodiment. As discussed above, the memory 112 may include classification rules 122. The classification rules 122 may be accessed and utilized by the event classifier 116 for the purpose of classifying the handling event messages as handling events. The classification rules 122 may be updated for each item handling service provider and/or for each customer of an item handling service provider. For example, a provider 302A may have multiple customers 304A, 304B of item handling services. The provider 302A may have the same classification rules for all of its recipients or customers of item handling services, or may customize its classification rules for each customer 304A, 304B of its item handling services. The provider 302A may set up, and may later update, its classification rules for the respective customer 304A, 304B of its item handling services. Similarly, another item handling service provider 302B may set up and/or update its own classification rules, which may be the same or different for each of its customers 306A, 306B.

The pricing rules 124, which may be accessed by the price determiner 118, may also be customized for each provider 308A, 308B of item handling services. The providers 308A, 30B may customize their respective pricing rules for each of their respective customers 310A, 310B, 312A, 312B according to contractual commitments with their respective customers. Thus, the price determiner 118 may determine prices for the classified handling events according to the respective pricing rules for each provider and customer of the item handling services.

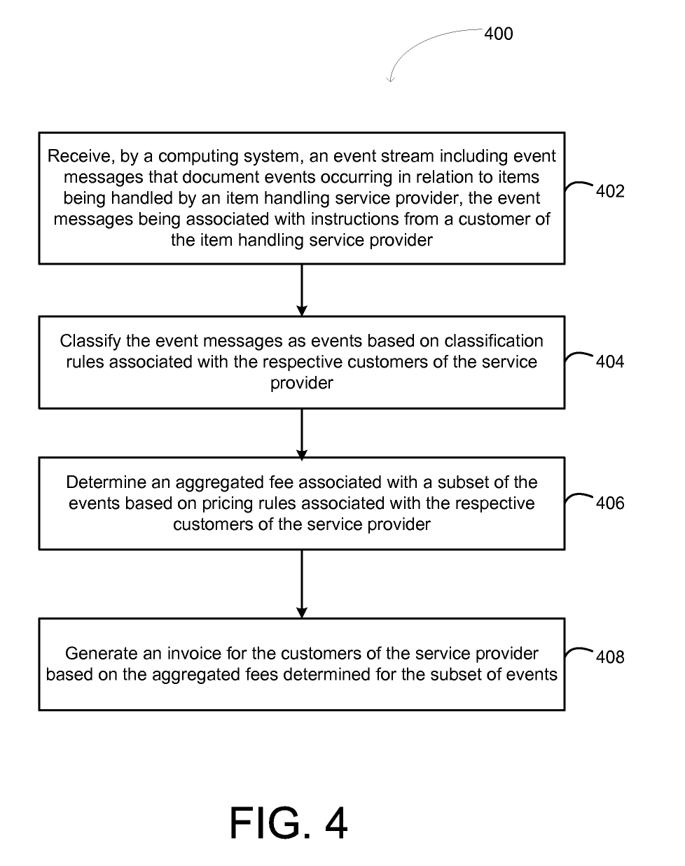

FIG. 4 is a flowchart of a method 400 according to an example embodiment. According to this example, the method 400 may include receiving, by a computing system, an event stream including handling event messages or event messages that document handling events or events occurring in relation to items being handled by an item handling service provider (402). The computing system may include any type of system capable of receiving input, performing functions or calculations based on the input, and providing an output based on the functions or calculations, such as the computing system 100 shown in FIG. 1. The event stream may include the handling event messages or event messages, such as the messages provided by the service providers 106A, 106B and contractors 108A, 108B discussed above with respect to FIG. 1. The handling event messages or event messages may be received in different formats, such as email, text message, web-based login and entry of data, and may be received according to different communication protocols, such as Ethernet, USB, IEEE 802.11, 802.15, 802.16, cellular communication and networking protocols, or any other communication or networking protocol. The handling event messages or event messages may each be associated with instructions from a customer of the item handling service provider. The handling event messages or event messages may, for example, be received in real time as the handling events or events are performed, or when the provider or contractor enters or sends the handling event message or event message.

In an example embodiment, the computing system may receive the handling event messages or event messages from at least two different sources.

In an example embodiment, the handling event message or event message may include item identifiers, timestamps, and time durations. The item identifiers may be associated with the timestamps and durations, and an invoice, discussed below, may be generated by applying the pricing rules to the item identifiers associated with the timestamps and time durations.

In an example embodiment, the handling event messages or event messages may be classified and the fees determined upon receipt of the handling event messages or event messages without storing the handling event messages or event messages in long-term memory (or read-only memory, such as a hard drive, flash memory, or magnetic tape).

The method 400 may also include classifying the handling event messages or event messages as handling events or events based on classification rules associated with the customers of the item handling service provider(s) (404). For example, the handling event messages or event messages may be classified according to the classification rules 122 discussed above with respect to FIGS. 1 and 3. The handling event messages or event messages may be classified as handling events or events such as, for example, transportation and warehouse services, or more specifically as inbound and outbound processing services, storage services, packaging services, handling services, inspection services, packaging services, and labeling services. The handling event messages or event messages may include identifiers such as item identifiers which may identify the particular item being transported, timestamps which may indicate a time of receipt or delivery of the items, and time durations which may include a time of storage or a time it took to actually transport the items. The item identifiers may be specifically associated with the timestamps and durations.

The method 400 may also include determining the aggregated fee associated with the subset of the handling events or events based on the pricing rules associated with the respective customers of the item handling service provider(s) (406). For example, the item handling events or events may be aggregated per provider of handling event services or event services, and may be further aggregated per customer of the item handling service provider. The handling events or events may also be further aggregated based, for example, on transactions such as transportation of a particular group of items which were ordered, or may be aggregated according to invoicing rules, such as monthly invoicing rules or transactional invoicing rules.

The method 400 may also include generating one or more invoices for the customers of the item handling service provider based on the aggregated fees determined for the subset of the handling events or events (408). For example, if the pricing rules require periodic billing, then the invoice may be generated per month, and may include all transactions for the given month or may include all deliveries for the given month depending on how the invoicing is triggered, or the invoice may be generated per transaction, such as based on delivery of the items in an example in which the invoices are generated per transaction, according to the pricing rules. The invoice may be triggered by a final event such as delivery, and may then include all of the handling items or events for the order preceding the delivery such as transportation, storage, and pickup of the items.

In an example embodiment, the pricing rules may specify periodic billing, and the invoice may be generated based on expiration of the period specified by the pricing rules.

In an example embodiment, the pricing rules may specify billing upon delivery of the items, and the invoice may be generated in response to a handling event message or event message being classified as a delivery event.

In an example embodiment, the invoice may list the handling events or events and fees associated with each of the handling events or events. The method 400 may include grouping the handling events or events into categories. At least one of the categories may include more than one handling event or event. The invoice may list each of the categories and a sum for the handling events or events included in each category.

In an example embodiment, the method 400 may include updating, based on a classification rules input, the classification rules for at least one customer of the item handling service provider, and update, based on pricing rules input, the pricing rules for at least one customer of the item handling service provider. The classification rules and pricing rules may be updated based on the provider of item handling services acquiring a new customer or recipient of item handling services, or renegotiating an agreement with an existing customer or recipient of item handling services.

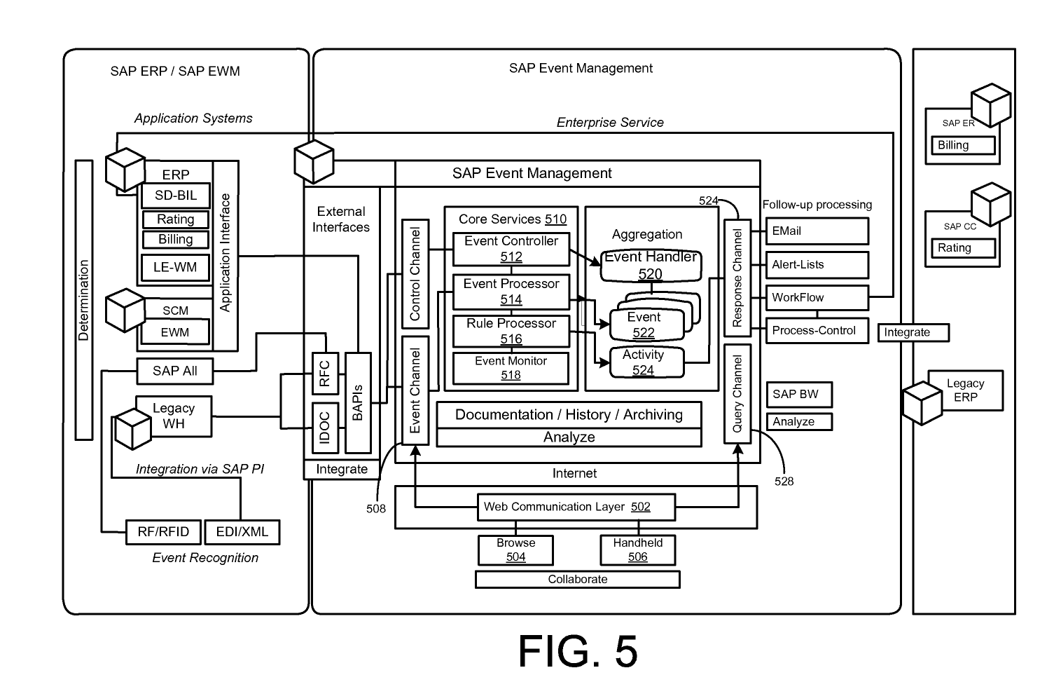

FIG. 5 is a block diagram of an architecture for processing handling event messages and generating invoices according to an example embodiment. The computing system 500 may include, for example, a communication layer 502 which may serve as an input node for receiving input from the providers and contractors. The communication layer 502 may, for example, receive input via a web browser 504 or via hand-held devices 506 such as tracking devices or computers, or input devices coupled to the computing system 500. The input received via the communication layer 502 may be provided to an event channel 508. The event channel 508 may receive and forward the data to a core services module 510.

The core services module 510 may receive and process the data received via the communication layer 502, which may include handling event messages. The core services module 510 may classify the data as handling events, and determine fees based on the events. For example, the core services module 510 may include an event controller 512. The event controller 512 may provide the handling events messages to an event handler 520. The event handler 520 may separate each of the handling event messages, which may then be classified as handling events 522 by an event processor 514. The event processor 514 may classify the handling event messages as handling events based on the classification rules 122 discussed above. A rule processor 516 may determine fees for the respective handling events 522. The event monitor 518 may determine whether a trigger has occurred for billing, or whether events have occurred which have not been billed for a determined amount of time, such as a month or three months, and should therefore be billed and have an invoice generated. The billed activities may be forwarded to a response channel 526 which may provide output in the form of invoices or alerts such as emails, alert lists, workflow which may lead to invoices or the control processors. The computing system 500 may also include a query channel 528, via which a user or the computing system 500 may request the computing system to generate an invoice or report of billable events.

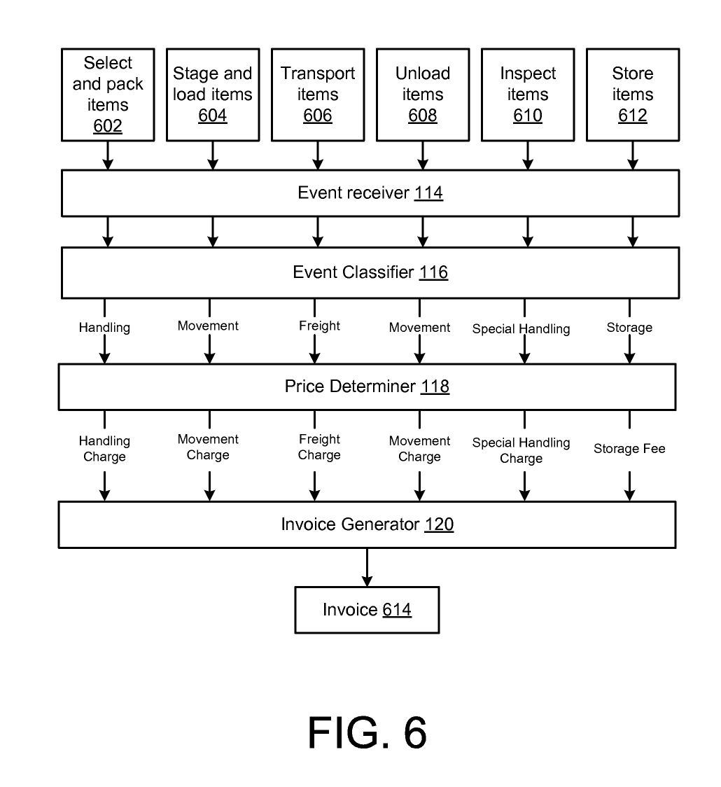

FIG. 6 is a block diagram showing modules of the processor of the computing system of FIG. 1, and data forwarded by the modules, according to another example embodiment. These events may be performed by, and associated event messages generated and sent by, any combination of item handling service providers and contractors.

For example, a handling event may include selecting and packing items 602. A handling event message may be provided to the event receiver 114, which may forward the handling event message, indicating that items were selected and packed, to the event classifier 116. The event classifier 116 may classify selecting and packing items 602 as handling. The event classifier 116 may forward the handling classification to the price determiner 118. The price determiner 118 may determine a handling charge associated with the classified handling according to the pricing rules. The handling charge associated with the handling may be based, for example, on the contract with the customer of the item handling service provider, the number of items, the weight of the items, the volume of the items, how long the items are to be stored, and/or how far the items are to be shipped. The price determiner 118 may provide the handling charge to the invoice generator 120.

Staging and loading items 604 may also be performed, and an associated handling event message provided to the event receiver 114. The event receiver 114 may forward the handling event message indicating the staging and loading items to the event classifier 116. The event classifier 116 may, according to the classification rules, classify the staging and loading items 604 as a movement classification and forward the movement classification to the price determiner 118. The price determiner 118 may determine the price for the movement classification or classified movement according to the pricing rules, which may be based on the agreement between and pricing rules for the respective provider and customer of the item handling services, and may be based on the number, weight, and/or volume of the items, as well as other circumstances, such as whether fragile goods are included in the items. The price determiner 118 may include a movement charge associated with staging and loading the items and provide the movement charge to the invoice generator 120.

Transporting items 606 may also be performed, and a handling event message associated therewith provided to the event receiver 114. The event receiver 114 may forward the handling event message associated with the transporting the items to the event classifier 116. The event classifier 116 may classify transporting items as a freight event and forward the freight classification to the price determiner 118. The price determiner 118 may determine a price or fee associated with the classified freight or freight classification based, for example, on the agreements between and pricing rules for the provider and customer of the item handling services, the number, weight, or volume of the items, the distance to be traveled with the items, any areas which may necessitate higher prices such as congested areas, and other factors, such as whether any customs areas will have to be traveled through. The price determiner 118 may provide the freight charge to the invoice generator 120.

Unloading items 608 may be another item handling event for which a provider or contractor may provide an item handling event message to the event receiver 114, indicating that the items were unloaded at the delivery point. The event receiver 114 may forward the item handling event message indicating the unloading of the items to the event classifier 116. The event classifier 116 may classify the item handling event message as a movement according to the classification rules. In this example, the classification rules may classify the unloading of the items 608 as movement of items similar to the staging and loading the items 604. While in this example, staging and loading items 604 falls into the same classification as unloading items 608, other examples may place these handling events into different classifications, and other examples may have different classifications altogether. The event classifier 116 may provide the classified handling event of movement to the price determiner 118. The price determiner 118 may determine the price or fees associated with the movement handling event based, for example, on the number, weight or volume of the items, and based on the pricing rules and agreements between the provider and customer of the item handling services. The price determiner 118 may provide the determined price or fee associated with the movement or the movement charge to the invoice generator 120.

An inspect items 610 handling event may include, for example, inspecting the items upon receipt to determine that the current number have been received and/or that the items have not been broken. The service provider or contractor who inspected the items may provide a handling event message indicating the inspection of the items to the event receiver 114. The event receiver 114 may forward the item handling event message indicating the inspection of the items to the event classifier 116. The event classifier 116 may classify the inspection of the items as special handling, and forward the classified special handling event to the price determiner 118. The price determiner 118 may determine the price or fee associated with the special handling event based, for example, on the agreement or pricing rules between the provider and customer of the item handling services, the number, weight, and/or volume of the items, and/or based on other factors, such as the care with which the items must be inspected. The price determiner 118 may provide the determined special handling charge to the invoice generator 120.

Storing items 612 may also be performed by a provider or contractor. Storing items may, for example, include storing items in a warehouse. The provider or contractor may provide an associated item handling event message to the event receiver 114. The event receiver 114 may forward the item handling event message indicating the storage of the items to the event classifier 116. The item handling event message indicating the storage of the items may, for example, include an identification of the items, a number of the items, weight or volume of the items, and a length of time and/or specific days for which the items were stored. The event classifier 116 may receive the item handling event message and classify the storage of the items as a storage handling event. The event classifier 116 may forward the classified storage handling event to the price determiner 118. The price determiner 118 may determine a price or fee associated with the storage based, for example, on the agreement or pricing rules for the provider and customer of the item handling services, the number, weight and/or volume of the items, as well as other circumstances, such as whether warehouses were over capacity at the time of storage.

The invoice generator may aggregate the received fees or charges including the handling charge, movement charge, freight charge, special handling charge and storage fee charge, and generate an invoice 614. The invoice 614 may list each of the classified events and may, for example, group the classified events into categories. For example, movement of goods may be classified into a single category and listed for the customer, or the different events or charges, such as the handling charge, movement charge, freight charge, special handling charge, and storage fee, may be categorized together for each group of items which were shipped. The invoice 614 may be generated and provided to the customer of the item handling service provider.

The system and functions described above may help an item handling service provider to invoice its customers who receive item handling services accurately and promptly based on actual work performed, and may be flexible and responsive to accommodate multiple fee arrangements which may change over time. The system and function may allow the service provider to review and track the revenue impact of various operations described above.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the embodiments of the invention.

What is claimed is:

1. A non-transitory computer-readable storage medium comprising computer-readable instructions stored thereon that, when executed, are configured to cause a computing system to at least:
receive an event stream including event messages that document events occurring in relation to items being handled by an item handling service provider, the event messages being associated with instructions from a customer of the service provider;
classify the event messages as events based on classification rules associated with the respective customers of the service provider;
determine an aggregated fee associated with a subset of the events based on pricing rules associated with the respective customers of the service provider; and
generate an invoice for the customers of the service provider based on the aggregated fees determined for the subset of events.

2. The storage medium of claim 1, wherein the event messages are received from a least two different sources.

3. The storage medium of claim 1, wherein the event messages include item identifiers, timestamps, and time durations.

4. The storage medium of claim 3, wherein:
the item identifiers are associated with the timestamps and durations; and
the invoice is generated by applying the pricing rules to the item identifiers associated with the timestamps and time durations.

5. The storage medium of claim 1, wherein the event messages are classified and the fees are determined upon receipt of the event messages without storing the event messages in long-term memory.

6. The storage medium of claim 1, wherein:
the pricing rules specify periodic billing; and
the invoice is generated based on expiration of the period specified by the pricing rules.

7. The storage medium of claim 1, wherein:
the pricing rules specify billing upon delivery; and
the invoice is generated in response to an event message being classified as a delivery event.

8. The storage medium of claim 1, wherein the invoice lists the handling events and fees associated with each of the events.

9. The storage medium of claim 8, further configured to cause the computing system to:
group the events into categories, at least one of the categories including more than one event,
wherein the invoice lists each of the categories and a sum for the events included in each category.

10. The storage medium of claim 1, further configured to cause the computing system to:
update, based on classification rules input, the classification rules for at least one customer of the service provider; and
update, based on pricing rules input, the pricing rules for at least one customer of the service provider.

11. A method comprising:
receiving, by a computing system, an event stream including event messages that document events occurring in relation to items handled by an item handling service provider, the event messages being associated with instructions from a customer of the service provider;
classifying the event messages as events based on classification rules associated with the respective customers of the service provider;
determining an aggregated fee associated with a subset of the events based on pricing rules associated with the respective customers of the service provider; and
generating an invoice for the customers of the service provider based on the aggregated fees determined for the subset of events.

12. The method of claim 11, wherein the event messages are received from a least two different sources.

13. The method of claim 11, wherein the event messages include item identifiers, timestamps, and time durations.

14. The method of claim 11, wherein the event messages are classified and the fees are determined upon receipt of the event messages without storing the event messages in long-term memory.

15. The method of claim 11, wherein:
the pricing rules specify periodic billing; and
the invoice is generated based on expiration of the period specified by the pricing rules.

16. The method of claim 11, wherein:
the pricing rules specify billing upon delivery; and
the invoice is generated in response to an event message being classified as a delivery event.

17. The method of claim 11, wherein the invoice lists the events and fees associated with each of the events.

18. The method of claim 17, further comprising:
grouping the events into categories, at least one of the categories including more than one event,
wherein the invoice lists each of the categories and a sum for the events included in each category.

19. The method of claim 11, further comprising:
updating, based on classification rules input, the classification rules for at least one customer of the service provider; and
updating, based on pricing rules input, the pricing rules for at least one customer of the service provider.

20. An apparatus comprising:
at least one processor; and
at least one memory, the at least one memory comprising computer-readable instructions stored thereon that, when executed, are configured to cause the apparatus to at least:
receive an event stream including handling event messages that document events occurring in relation to items handled by an item handling service provider, the event messages being associated with instructions from a customer of the item handling service provider;
classify the event messages as events based on classification rules associated with the respective customers of the service provider;
determine an aggregated fee associated with a subset of the events based on pricing rules associated with the respective customers of the service provider; and
generate an invoice for the customers of the service provider based on the aggregated fees determined for the subset of events.
